(19) United States
(12) Patent Application Publication
(10) Pub. No.: US 2009/0244471 A1
(43) Pub. Date: Oct. 1, 2009

(54) LIQUID CRYSTAL DISPLAY DEVICE MANUFACTURING METHOD AND LIQUID CRYSTAL DISPLAY DEVICE

(75) Inventor: Yoshikazu Kondo, Tokyo (JP)

Correspondence Address: CANTOR COLBURN, LLP, 20 Church Street, 22nd Floor, Hartford, CT, 06103, US

(73) Assignee: KONICA MINOLTA HOLDINGS, INC., Tokyo (JP)

(21) Appl. No.: 12/373,480

(22) PCT Filed: Jun. 18, 2007
(86) PCT No.: PCT/JP2007/062224

§ 371 Date: Jan. 12, 2009

(30) Foreign Application Priority Data
Jul. 14, 2006 (JP) 2006-193912

(51) Int. Cl. G02F 1/1333; G02F 1/13

(52) U.S. Cl. 349/158; 349/187

(57) ABSTRACT

A method of manufacturing a liquid crystal display device which is provided with a liquid crystal display panel including a liquid crystal layer, a first transparent base board pasted on an display surface side of the liquid crystal layer and a second transparent base board pasted on a back side of the liquid crystal layer, and a backlight unit to make light to transmit toward the display surface side of the liquid crystal display panel, comprises a step of making a mixed gas including a transparent conductive layer forming gas and at least a rare gas as a discharging gas into an excited state by an atmospheric pressure plasma process such that a transparent conductive layer is formed on the display side surface of the first transparent base board.

### TECHNICAL FIELD

The present invention relates to a liquid crystal display device manufacturing method and a liquid crystal display device, in particular, to a liquid crystal display device manufacturing method and a liquid crystal display device which comprises a transparent conductive layer excellent in optical transparency, resistance characteristic and adhesive ability for a base material.

### BACKGROUND ART

Generally, liquid crystal display devices with a active matrix employing TFT comprises an active matrix base board in which picture element electrodes and TFT to control voltage to be applied onto the picture element electrodes are arranged in a matrix arrangement, and is structured such that a liquid crystal is sandwiched between the active matrix board and an opposite base board and the liquid crystal is driven by voltages applied between picture element electrodes and another electrodes. In this case, there are a vertical electric field type liquid crystal display device in which picture element electrodes on an active matrix base board are structured with transparent electrodes, another electrodes are structured with transparent common electrodes formed on an opposite board and liquid crystals are driven by voltage applied between the transparent electrodes and the transparent common electrodes, and a transverse electric field type liquid crystal display device in which picture element electrodes and common electrodes on an active matrix board are structure with paired pectinate electrodes and liquid crystals are driven by voltage applied between these electrodes. At any rate, it is necessary to form the TFT and picture element electrodes minutely on an active matrix board, and currently these TFT and picture element electrodes are formed with a photolithographic technique.

Generally, in transverse electric field type liquid crystal display devices which are compared with vertical electric field type liquid crystal display devices, two transparent base boards are arranged to oppose to each other through a liquid crystal layer, electrodes for display and reference electrodes are provided on a surface of a region corresponding to unit picture element at a liquid crystal layer side on one or both of the two transparent base boards, and electrical fields are generated between the electrodes for display and the reference electrodes in parallel to the transparent base boards so as to modulate light transmitting through the liquid crystal layer.

On the other hand, in vertical electric field type liquid crystal display devices, two transparent base boards are arranged to oppose to each other through a liquid crystal layer, picture element electrodes made of transparent electrodes and common electrodes are provided to oppose to each other on respective surfaces of regions at each liquid crystal side of the two transparent base boards, and electrical fields are generated between the picture element electrodes and the common electrodes in perpendicular to the transparent base boards so as to modulate light transmitting through the liquid crystal layer. It has been well known that being different from such vertical electric field type liquid crystal display devices, vertical electric field type liquid crystal display devices are excellent in so-called a viewing field with an angle in which a clear image can be recognized even if the image is observed with a viewing field with a large angle to a display surface. Here, with regard to liquid crystal display devices composed of such a structure, for example, PCT Application Unexamined Publication No. 5-505247, Japanese Patent No. 63-21907 and Japanese Patent Unexamined Publication No. 6-160878 disclose them in detail.

In such transverse electric field type liquid crystal display devices, in the case that the surface of a liquid crystal display panel is applied with high voltage such as static electricity from the outside, caused is adverse effects such as the occurrence of abnormal indication which has not been seen in vertical electric field type liquid crystal display devices. That is, the transverse electric field type liquid crystal display devices are structured to not have at all a conductive layer with a shielding function for static electricity from the outside between electrodes for display and reference electrodes arranged in parallel or almost parallel to each other through liquid crystals. If such a conductive layer is arranged, since electric fields terminate at a conductive layer side not at a reference electrode side, a proper indication with the electric field cannot be performed.

Further, since it has not such a shielding function, electric fields corresponding to picture signals and generated in parallel to transparent base boards between electrodes for display and reference electrodes are influenced by static electricity and the like from the outside. This static electricity from the outside electrically charges a liquid crystal display panel itself and this charge generates electric fields vertical to a transparent base board.

For the above problems, disclosed is a liquid crystal display device capable of preventing the occurrence of abnormal indications with a structure to form a conductive layer having an optical transparency by a spattering method on a surface of a transparent base board opposite to a liquid crystal layer in a transverse electric field type liquid crystal display device even if the surface of a liquid crystal display panel is applied with high voltage such as static electricity from the outside (for example, refer to Patent document 1).

However, in the case that a conductive layer is formed by a spattering method in a transverse electric field type or vertical field type liquid crystal display device, it became clear that short circuits easily take place on electrode section, a transparent base board is easily damaged, and the breakage of the board is caused. Further, the current state is that when a conductive layer is formed by a spattering method after liquid crystals are filled in a liquid crystal layer, since air bubbles are generated in the liquid crystal layer, a high grade liquid crystal display device cannot be obtained.

Further, a method of forming a conductive layer by coating a coating liquid containing conductive fine particles has been well known. However, in this method, since it is necessary to conduct a sintering process under high temperature after drying a conductive layer formed by a coating method, a lot of time is needed for forming the conductive layer and there are problems that the optical transparency of the formed conductive layer decreases and the adhesive of the conductive layer with a base material is low.

Patent document 1: Japanese Patent 2758864 (Official gazette)

### DISCLOSURE OF THE INVENTION

### Problems to be Solved by the Invention

The present invention has achieved in view of the above problems, and an object of the present invention is to provide a liquid crystal display device manufacturing method and a liquid crystal display device which comprises a transparent conductive layer excellent in optical transparency, resistance characteristic and adhesive ability for a base material.

### Means for Solving the Problems

The above object of the present invention can be achieved by the following structures.

1. In a liquid crystal display device manufacturing method in which a liquid crystal display device is provided with a liquid crystal display panel and a back light unit to transmit light to a display surface side of the liquid crystal display panel, the liquid crystal display panel is provided with electrodes for display and reference electrodes on a surface of a region corresponding to unit picture elements at a liquid crystal side of one or both of transparent base boards arranged to oppose to each other across a liquid crystal layer, and the liquid crystal display device is further provided with a structure to modulate light transmitting the liquid crystal layer by electric fields generated in parallel to the transparent base board between the reference electrodes and the display electrodes to be supplied with picture signals from picture signal lines through at least switching elements; the liquid crystal display device manufacturing method is characterized in that a transparent base board located at a farther side from the back light unit among the transparent base boards of the liquid crystal display panel becomes a transparent base board as a side not provided with the switching elements and has a transparent conductive layer having translucency at a surface side of the transparent base board at an opposite side to a liquid crystal layer and the transparent conductive layer is formed on at least a picture element region by an atmospheric plasma method employing at least rare gas as a thin layer forming gas.
2. The liquid crystal display device manufacturing method described in the above 1 is characterized in that the liquid crystal display device is provided with electrodes for display and reference electrodes on a surface of a region corresponding to unit picture elements at a liquid crystal side of one of transparent base boards arranged to oppose to each other through a liquid crystal layer and the liquid crystal display device is a transverse electrical field type to modulate light transmitting the liquid crystal layer by electric fields generated in parallel to the transparent base boards between the reference electrode and the display electrode to be supplied with picture signals from picture signal lines through at least switching elements.
3. The liquid crystal display device manufacturing method described in the above 1 or 2 is characterized in that the rare gas is an argon gas.
4. The liquid crystal display device manufacturing method described in any one of the above 1 to 3 is characterized in that after liquid crystals are filled in a liquid crystal layer provided between the transparent base boards, the transparent conductive layer having translucency is formed on a surface side of the transparent base board at an opposite side to the liquid crystal layer by an atmospheric plasma method employing at least rare gas as a thin layer forming gas.
5. In a liquid crystal display device in which a liquid crystal display device is provided with a liquid crystal display panel and a back light unit to transmit light to a display surface side of the liquid crystal display panel, the liquid crystal display panel is provided with electrodes for display and reference electrodes on a surface of a region corresponding to unit picture elements at a liquid crystal side of one of both of transparent base boards arranged to oppose to each other through a liquid crystal layer, and the liquid crystal display device is further provided with a structure to modulate light transmitting the liquid crystal layer by electric fields generated in parallel to the transparent base board between the reference electrodes and the electrodes for display supplied with picture signals from picture signal lines through at least switching elements; the liquid crystal display device is characterized in that a transparent base board located at a farther side for the back light unit among transparent base boards of the liquid crystal display panel becomes a transparent base board as a side not provided with the switching elements and has a transparent conductive layer having translucency at a surface side of the transparent base board at an opposite side to a liquid crystal layer and the transparent conductive layer is formed on at least a picture element region by an atmospheric plasma method employing at least rare gas as a thin layer forming gas.
6. The liquid crystal display device described in claim 5 is characterized in that electrodes for display and reference electrodes are provided on a surface of a region corresponding to unit picture elements at a liquid crystal side of one of transparent base boards arranged to oppose to each other through a liquid crystal layer and the liquid crystal display device is a transverse electrical field type to modulate light transmitting the liquid crystal layer by electric fields generated in parallel to the transparent base boards between the reference electrode and the electrode for display supplied picture signals from picture signal lines through at least switching elements.
7. The liquid crystal display device described in the above 5 or 6 is characterized in that the rare gas is argon gas.
8. The liquid crystal display device described in any one of the above 5 to 7 is characterized in that after liquid crystals are filled in a liquid crystal layer provided between the transparent base boards, the transparent conductive layer having translucency is formed at a surface side of the transparent base board at an opposite side to the liquid crystal layer by an atmospheric plasma method employing at least rare gas as a thin layer forming gas.

### EFFECT OF THE INVENTION

According to the present invention, it becomes possible to provide a liquid crystal display device manufacturing method and a liquid crystal display device which comprises a transparent conductive layer excellent in optical transparency, resistance characteristic and base material adhesion.

### BRIEF DESCRIPTION OF THE DRAWING

FIG. 1 is an outlined sectional view showing an example of the constitution of a liquid crystal display element of the present invention equipped with a back light unit.

FIG. 2 is an outlined sectional view showing an example of the constitution of a liquid crystal display element which performs a full color indication.

FIG. 3 is an outlined sectional view showing another example of the constitution of a liquid crystal display element of the present invention.

FIG. 4 is a schematic diagram showing an example of a plasma jet type atmospheric pressure plasma discharge processing apparatus according to the present invention.

FIG. 5 is a schematic diagram showing another example of the plasma jet type atmospheric pressure plasma discharge processing apparatus according to the present invention.

FIG. 6 is a schematic diagram showing an example of a direct type atmospheric pressure plasma discharge processing apparatus according to the present invention.

### EXPLANATION OF REFERENCE SYMBOLS

1 Color filter base board
2 Array base board
3, 104 Liquid crystal layer
4, 105, Sealing members
5a, 5b, 103A, 103B Transparent base board
6 Black matrix region
7R, 7G, 7R Color picture element region
8 Protective film
9 Transparent electrode film (Electrode)
10a, 10b Orientating film
11 Solid spherical spacer
12, 102 Transparent conductive layer
13, 107 Back light unit
21 Atmospheric pressure plasma discharge processing apparatus
22 Gas containing discharge gas
23 Mixed gas
24, 25 Flow passage
27 Electrode cooling member
31 Power source
41, 41a, 41b Electrode
42 Derivative
43 Discharge space
44 Hollow structure
45 Mixing space
46 Base material
47 Moving stage, Moving stage electrode
48 Waste exhaust gas flow passage
49 Waste gas flow passage forming member
100 Liquid crystal display panel
101, 106 Polarizing plate
A Upper base board
B Lower base board
C, D, E Electrode unit
G Gas
L Liquid crystal (polarizer)

### BEST MODE FOR CARRYING OUT THE INVENTION

Hereafter, the best mode for carrying out the present invention will be explained.

As a result of the keen investigation conducted earnestly by the present inventor in view of the above problems, in a liquid crystal display device manufacturing method in which a liquid crystal display device is provided with a liquid crystal display panel and a back light unit to transmit light to a display surface side of the liquid crystal display panel, the liquid crystal display panel is provided with electrodes for display and reference electrodes on a surface of a region corresponding to unit picture elements at a liquid crystal side of one of both of transparent base boards arranged to oppose to each other through a liquid crystal layer, and the liquid crystal display device is further provided with a structure to modulate light transmitting the liquid crystal layer by electric fields generated in parallel to the transparent base board between the reference electrodes and the electrodes for display supplied with picture signals from picture signal lines through at least switching elements; the present inventor conceived the liquid crystal display device manufacturing method characterized in that a transparent base board located at a farther side for the back light unit among transparent base boards of the liquid crystal display panel becomes a transparent base board as a side not provided with the switching elements and has a transparent conductive layer having translucency at a surface side of the transparent base board at an opposite side to a liquid crystal layer and the transparent conductive layer is formed on at least a picture element region by an atmospheric plasma method employing at least rare gas as a thin layer forming gas. Further, the present inventor found that with the above liquid crystal display device manufacturing method, it becomes possible to realize a manufacturing method of a liquid crystal display device comprising a transparent conductive layer excellent in optical transparency, resistance characteristic and adhesive ability for a base material, and the present inventor achieved the present invention.

Conventionally, a vacuum deposition, a sputtering method, an ion plating method, a coating method and the like have known as a method of forming a transparent conductive layer on only a transparent base board. However, in a method of forming a transparent conductive layer for the surface of a liquid crystal display element having been assembled, there are many difficulties from the viewpoint for influences for liquid crystal display element components and operations for forming a transparent conductive layer in a form of a thin layer having an extremely high transparency.

As stated above, a method of forming a transparent conductive layer by coating a coating liquid containing conductive fine particles onto the surface of liquid crystal display element components may be nominated. However, in this method, since it is necessary to conduct a sintering treatment under high temperature after the conductive layer formed by the coating method have been dried, the liquid crystal display element components themselves will be obliged to be exposed to the high temperature, whereby the liquid crystal display element components will be influenced greatly. Further, it will take much time to form a conductive layer, and it is extremely difficult to form a conductive layer with a uniform layer thickness on the surface of an assembled liquid crystal display element. Therefore, there are problems that the optical transparency of a formed conductive layer becomes lower and its adhesive ability for a base material is low. Further, in a method of forming a conductive layer by a vacuum deposition method, for example, since the method has to be conducted under sever conditions such as under vacuum, there are problems that these sever conditions provide some influences to the characteristics and quality of an assembled liquid crystal display element and building up the manufacturing process becomes difficult and needs large scale works. Also, in a method of forming a transparent conductive layer on the surface of an assembled liquid crystal display element by a sputtering method, it turns out that an electric short circuit easily takes place on electrode sections and some damages easily take place on a transparent base board, thereby causing breakages of the transparent base board and the like. Further, if a conductive layer is formed on the condition where a liquid crystal layer is filled with liquid crystal, it becomes clear that vapors and the like are generated in the liquid crystal layer such that a high grade liquid crystal display apparatus can not be obtained.

As a result of the keen investigation that the present inventor conducted earnestly for the above problems, with the process of forming a conductive layer on a transparent base board being a surface member of an assembled liquid crystal display element by an atmospheric pressure plasma method employing at least rare gas as a thin layer forming gas, it becomes possible to form a conductive layer at an atmospheric pressure or a pressure near to the atmospheric pressure and a processing temperature at the time of forming a conductive layer can be suppressed to a relatively low temperature. Therefore, thermal influence for liquid crystal display element components can be refrained, and then a transparent conductive layer excellent in optical transparency, resistance characteristic and adhesive ability for a base material can be obtained with a simple method without causing electric short circuits and breakage of a transparent base board.

Hereafter, the present invention will be explained in detail.

<<Liquid Crystal Display Elements>>

At the outset, a basic constitution of a liquid crystal display element of the present invention is explained with reference to drawings. Here, the constitution of a liquid crystal display element of the present invention is not limited to the drawings exemplified here.

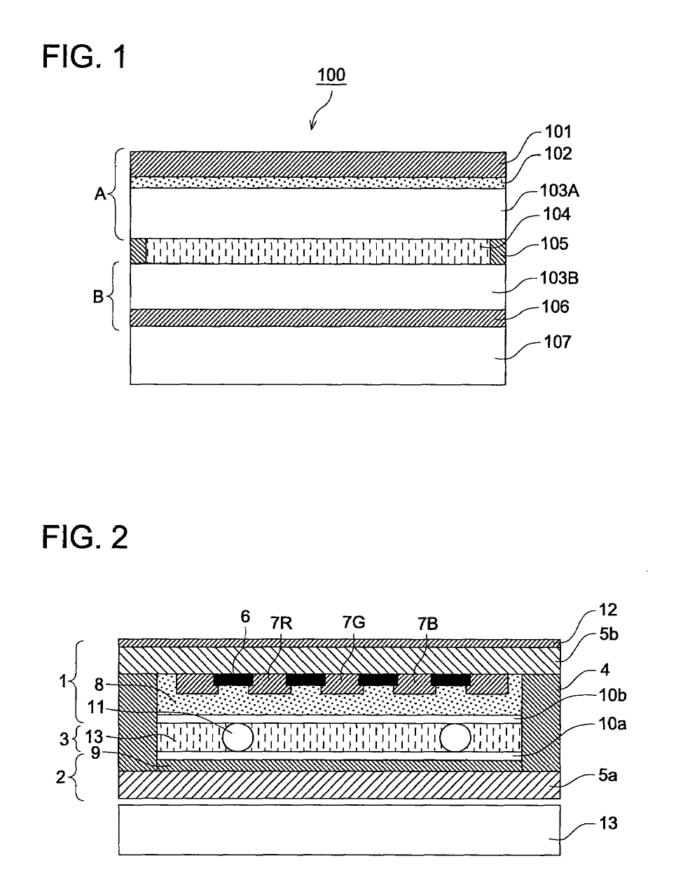

FIG. 1 is an outlined sectional view showing an example of the constitution of a liquid crystal display element of the present invention equipped with a back light unit.

In FIG. 1, in a liquid crystal display panel 100, a transparent base board 103A and a transparent base board 103B are arranged at respective positions opposite to each other across a liquid crystal layer 104 with its both ends sealed with sealing members 105 and a main surface side (the upper side in the drawing) of the transparent base board 103A is arranged at an observing side. At the transparent base board 103B side, arranged is a back light unit 107, and uniform observation light is adapted to be irradiated from the back light unit 107 to an almost entire region of the transparent base board 103B.

The liquid crystal layer 104 formed between the transparent base board 103A and the transparent base board 103B is structured such that a plurality of picture elements are arranged in a matrix form in the transverse direction of the liquid crystal layer 104 together with electric circuits formed at the liquid crystal layer 104 side of each transparent base board.

The aggregation of each picture element arranged in the matrix form constitutes an indication region when being observed from the transparent base board 103A side.

Each picture element constituting the indication region is adapted respectively to control the transmission of light from the back light unit 107 in accordance with signals supplied through an electronic circuit, whereby arbitrary images can be displayed on the indication region.

It is desirable to adopt what is called a transverse electric field system in which the control of the light transmission in each picture element is conducted is such a way that an electric field generated in the liquid crystal layer 104 in each picture element is formed in parallel to the surface of the transparent base board.

In a liquid crystal display pane 100 of the transverse electric field system constituted in this way, as same as that of a vertical electric field system, polarizing plates 101 and 106 are pasted on the surface (the surface at the observing side) of the transparent base 103A at the opposite side to the liquid crystal layer 104 and on the surface (the surface at the back light unit 107 side) of the transparent base board 103B at the opposite side to the liquid crystal layer 104.

The liquid crystal display element of the present invention is especially characterized by comprising a transparent conductive layer 102 formed by an atmospheric pressure plasma process employing at least rare gas as a thin film forming gas between the polarizing plate 101 pasted at the side of the transparent base 103A and the transparent base 103A. This transparent conductive layer 102 functions as an electric conduction film to conduct shielding for electrically charging such as static electricity from the outside and the like.

FIG. 2 is an outlined sectional view showing an example of the constitution of a liquid crystal display element which performs a full color indication.

In FIG. 2, in an array board 2 under a liquid crystal layer 3, an orientating layer 10a, a transparent electrode layer 9, and a transparent base board 5a are constituted in this order, and a backlight 13 is provided at the side of the transparent base board 5a opposite to the transparent electrode. On the array board 2, there are provided sealing members 4 formed at peripheral regions to surround a display region provided with a liquid crystal layer 3 containing liquid crystal 13, and the liquid crystal layer 3 includes a small amount (for example, 0.3% by weight) of solid spherical spacers 11. A color filter board 1 is structured with color picture element regions 7R, 7G, and 7B at a central area and black matrix regions 6 at the peripheral area. A transparent base board 5b is arranged on the upper part of the color picture element regions at the central area, and on the upper part of transparent base board 5b, there is provided a transparent conductive layer 12 formed by an atmospheric pressure plasma process employing at least rare gas as a thin film forming gas.

In a process of assembling an liquid crystal display element, the array board 2 and the color filter board 1 are arranged in a vacuum chamber of a vacuum assembling apparatus on a condition that there is provided a space between them, and the color filter board 1 is correctly arranged on the array board 2 under atmospheric pressure. When two boards are made to join while the atmospheric pressure in the vacuum chamber is being reduced, the color filter board 1 is stacked up on the array board 2. The sealing members are pasted with, for example, adhesives containing resin curable with application of ultraviolet rays. Subsequently, the transparent conductive layer 12 is formed on the transparent base board 5b by the atmospheric pressure plasma process employing rare gas. Thereafter, liquid crystal is injected into the liquid crystal layer 3 by a vacuum injecting method through an opening section of the sealing member 4, and then the opening section of the sealing member 4 is closed, whereby a liquid crystal display element to perform a full color indication is formed.

As the above method of injecting liquid crystal into a liquid crystal layer after the liquid crystal display elements has been assembled, adopted is a method of injecting liquid crystal into a liquid crystal layer by a vacuum injecting method on the condition that the portion corresponding to the liquid crystal layer is surrounded and sealed by the sealing members and is made empty. However, this method needs much time to fill the liquid crystal into the portion of the liquid crystal layer, and a large amount of liquid crystal adheres to the circumference. As a result a post cleaning process is needed, or the loss of liquid crystal increases. Therefore, there are matters to be improved in terms of time and economically.

To counter the above problems in the method of injecting liquid crystal into a liquid crystal layer after a liquid crystal display element has been assembled, adopted is a liquid crystal dropping method in which, before an upper transparent base board is stacked on a lower transparent base board after sealing members have been provided at peripheral regions to surround a display region on the lower transparent base board, liquid crystal is dropped into the display region, and then he upper transparent base board is stacked on the lower transparent base board so as to form a liquid crystal layer. The liquid crystal dropping method is called One Drop Fill Method (ODF method) and it is preferable to adopt this ODF method in the manufacturing method of a liquid crystal display element of the present invention. With regard to the details of this ODF method, for example, a technique disclosed in the specification of U.S. Pat. No. 5,263,888 (Teruhisa Ishihara et al, Nov. 23, 1993) can be referred to.

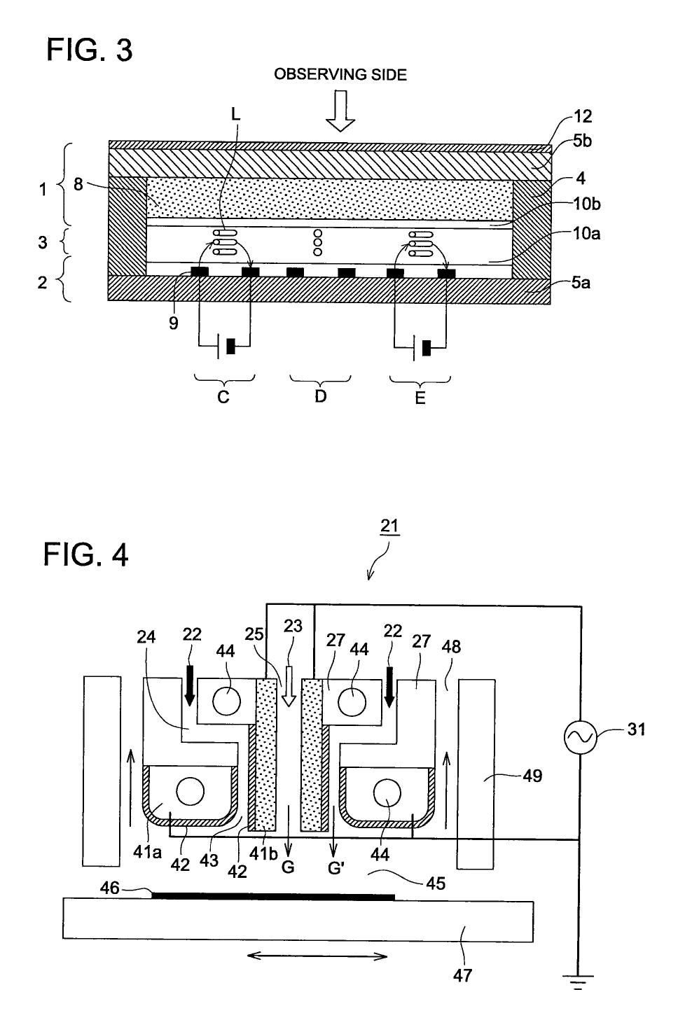

FIG. 3 is an outlined sectional view showing another example of the constitution of a liquid crystal display element of the present invention.

Different from the liquid crystal display elements shown in FIGS. 1 and 2 in which a transparent electrode layer is arranged onto the entire surface of one side, in a liquid crystal display element shown in FIG. 3, a plurality of paired electrodes 9 are provided on the surface of one side of a transparent base board between a liquid crystal layer and the transparent base board, and a voltage is applied independently for each paired electrodes in such a way that the orientation of liquid crystal (polarizer) in the liquid crystal layer is changed to indicate an image.

In FIGS. 1-3, the transverse electric field system in which electrodes are provided on the surface of one side of a transparent base board between the transparent base board and a liquid crystal layer is explained. However, as the structure of the liquid crystal display element of the present invention, a vertical electric field system in which electrodes are provided on both sides on both across a liquid crystal layer can also be adopted.

<<Transparent Conductive Layer>>

The liquid crystal display element of the present invention has a transparent conductive layer provided with a optical transparency at the side of a transparent base board opposite to a liquid crystal layer, and is characterized in that this transparent conductive layer (also called a transparent conductive film) is formed in at least a picture element region by an atmospheric pressure plasma process employing rare gas as thin film forming gas. Hereafter, a transparent conductive film forming material and an atmospheric pressure plasma process to form a transparent conductive film are explained.

(Transparent Conductive Film Forming Material)

As the main components of the transparent conductive layer according to the present invention, preferably employed is at least one kind of transparent conductive film forming materials selected from In₂O₃, Sn doped indium oxide (ITO), ZnO, In₂O₃—ZnO type amorphous oxide (IZO), Al doped ZnO(AZO), Ga doped ZnO (GZO), SnO₂, F doped SnO₂ (FTO) and TiO₂. An ITO film and an AZO film have an amorphous structure or a crystalline structure. On the other hand, an IZO film has an amorphous structure.

In the present invention, the area resistance of a transparent conductive layer is preferably 1×10⁹ Ω/□ or less, more preferably 1×10⁶ Ω/□ or less.

The method of forming a transparent conductive layer to according to the present invention is characterized in that raw materials are formed by an atmospheric pressure plasma process which performs plasma treatment under an atmospheric pressure or a pressure near the atmospheric pressure.

Examples of reactive gas used for forming metal oxide layers being main components of a transparent conductive layer by an atmospheric pressure plasma process, include one kind of organic metal compounds, such as metal alkoxide, metal alkyl, β-diketonate, metal carboxylate, metal dialkyl amide, and the like. Further, double alkoxide composed of two kinds of metals and compounds substituted partially with other organic groups can be used. However, especially, compounds having volatility can used preferably.

Examples of reactive gas include indiumhexafluoro pentanedionate, indium methyl(trimethyl) acetyl acetate, indium acetylacetonato, indium iso propoxide, indium trifluoro pentanedionate, tris(2,2,6,6-tetramethyl-3,5-heptane dionate) indium, di-n-butylbis(2,4-pentanedionate) tin, di-n-butyldiacetoxytin, di-t-butyldiacetoxytin, tetra-isopropoxy tin, tetra-butoxytin, zinc acetylacetonato, and the like. Among these, especially desirable are indium acetylacetonato, tris(2,2,6,6-tetramethyl-3,5-heptane dionate) indium, zinc acetylacetonato, and di-n-butyldiacetoxytin. Moreover, among the above compounds, examples of materials for forming a layer of a tin oxide layer (SnO₂), include dibutyltin diacetate, tetrabutyltin, and tetra-methyl tin, and the like. Furthermore, fluorine or antimony may also be included in the tin oxide layer.

Examples of reactive gas used for doping, include aluminium isopropoxide, nickel acetylacetonato, manganese acetylacetonato, boron isopropoxide, n-butoxyantimony, tri-n-butylantimony, di-n-butylbis(2,4-pentanedionate) tin, di-n-butyldiacetoxytin, di-t-butyldiacetoxytin, tetra-isopropoxy tin, tetra-butoxytin, tetra-butyltin, zinc acetylacetonato, 6 propylene fluoride, 8 cyclobutane fluoride, and 4 methane fluoride, and the like.

Examples of reactive gas used for adjusting the resistance of a transparent conductive layer, include titanium triso propoxide, tetra-methoxy silane, tetra-ethoxysilane, hexamethyl, disiloxane and the like.

(Atmospheric Pressure Plasma Process)

Hereafter, an atmospheric pressure plasma process applied to form a transparent conductive layer according to the present invention will be explained.

As compared with a plasma CVD method under a vacuum, since the atmospheric pressure plasma process performing a plasma treatment under a pressure near the atmospheric pressure need not to reduce pressure, not only productivity is high, but also plasma density is high density. Therefore, a film forming speed is fast. Further, as compared with the condition of a general CVD method, since an average free process of gas is very short under a high pressure condition of the atmospheric pressure, an extremely flat film can be obtained, and such a flat film has good optical characteristics.

In the transparent conductive layer according to the present invention, gas containing a transparent conductive layer formation gas is supplied and excited under an atmospheric pressure or a pressure near the atmospheric pressure in a discharge space in which a high frequency electric field is generated, and a transparent base board is exposed to the excited gas so that a transparent conductive layer is formed the transparent base board.

The atmospheric pressure or a pressure near the atmospheric pressure used in the present invention is about 20 kPa to 110 kPa, and in order to acquire the good effect described in the present invention, a pressure of 93 kPa to 104 kPa is desirable.

Moreover, the excited gas used in the present invention obtains energy means gas whose at least some molecules shift from a certain status to a higher status by obtaining energy, and the excited gas corresponds to gas containing excited gas molecules, radical gas molecules, or ionized gas molecules.

Namely, a process of forming a transparent conductive layer is conducted in such a way that a space between opposite electrodes is made an atmospheric pressure or a pressure near the atmospheric pressure, a metal oxide (transparent conductive layer) forming gas containing a discharge gas and a metal oxide gas is introduced between the opposite electrodes, a high frequency voltage is applied between the opposite electrodes so as to make the metal oxide forming gas into a plasma state, subsequently a board is exposed to the metal oxide forming gas in the plasma state, whereby a transparent conductive layer is formed on a transparent base board.

Next, gas to form the transparent conductive layer according to the present invention will be explained. The gas to be used is gas which includes a discharge gas and a transparent conductive layer forming gas as constituent components.

The discharge gas is a gas which becomes an excited state or a plasma state in a discharge space and bears a role to gives energy to a transparent conductive layer forming gas so as to become an excited state or a plasma state, and the present invention is characterized by using rare gas as the discharge gas. Examples of rare gas include the 18th group elements in a periodic table, concretely, helium, neon, argon, krypton, xenon, radon, and the like. The discharge gas is desirably contained in an amount of 90.0 to 99.9% by volume to 100% by volume of the entire gas.

In the formation of a transparent conductive layer according to the present invention, the transparent conductive layer forming gas is gas which becomes an excited state or a plasma state by receiving energy from a discharge gas in a discharge space and forms a transparent conductive thin layer, and is also gas which controls a reaction or promotes a reaction. This transparent conductive layer formation gas is desirably contained in an amount of 0.01 to 10 volume % in all the gas, and more preferably in an amount of 0.1 to 3 volume %.

In the present invention, in the formation of a transparent conductive layer, by making a transparent conductive layer formation gas to contain a reductive gas selected from hydrocarbons such as hydrogen and methane and water, a formed transparent conductive thin layer can be more dense and uniformly, and thereby enhancing conductivity, adhesive ability, and cracking resistance. The reductive gas is desirably contained in an amount of 0.0001-10 volume % to 100 volume % of all the gas, and more preferably in an amount of 0.001 to 5 volume %.

Moreover, a transparent conductive layer according to the present invention can be formed by exposing a discharge gas and an oxidized gas to a gas excited to a plasma state, and examples of the oxidized gas used for the present invention include oxygen, ozone, hydrogen peroxide, carbon dioxide, and the like. A gas chosen from helium and argon can be used as the discharge gas at this time. The concentration of an oxidized gas component in the mixed gas composed of an oxidized gas and a discharge gas is desirably 0.0001 to 30 volume %, more desirably 0.001 to 15 volume %, and especially desirably 0.01 to 10 volume %. The optimal value of each concentration of an oxidized gas and a discharge gas chosen from helium and argon can be selected suitably in accordance with the temperature of a board, the number of times of oxidation treatment and a processing time period. As the oxidized gas, oxygen and carbon dioxide are desirable, and the mixed gas of oxygen and argon is still more desirable. Moreover, in order to control the region of discharge, several percent to several tens percent of nitrogen can also be mixed.

Next, an atmospheric pressure plasma process according to the present invention will be explained with reference to drawings.

As an atmospheric pressure plasma discharge processing apparatus applicable to the present invention, there is no restriction in particular. However, there are the following two types as a large category.

One type is a type called a plasma jet type atmospheric pressure plasma discharge processing apparatus in which a high frequency voltage is applied between opposite electrodes, a mixed gas containing a discharge gas is supplied between the opposite electrode so that this mixed gas is made to plasma, subsequently the mixed gas in the state of plasma and a transparent conductive layer forming gas are associated and mixed, and thereafter the resultant mixed gas is sprayed onto a transparent base board material, whereby a transparent conductive layer is formed on the transparent base board.

Another type is a type called a direct type atmospheric pressure plasma discharge processing apparatus in which a mixed gas containing a discharge gas and a transparent conductive layer forming gas are mixed, then the resultant mixed gas is introduced into a discharge space on the condition that a transparent base board material is held between opposite electrodes, subsequently a high frequency voltage is applied between the opposite electrodes so that a transparent conductive layer is formed on the transparent base board.

FIG. 4 is a schematic diagram showing an example of a plasma jet type atmospheric pressure plasma discharge processing apparatus according to the present invention. Here, the present invention is not limited to this embodiment. Further, although there may be the case where the following explanation includes an affirmative expression to the terminology and the like, it indicates a preferable example of the present invention and does not limit the meaning of the terminology and the technical scope of the present invention.

In FIG. 4, in an atmospheric pressure plasma discharge processing apparatus 21, two pairs of paired electrodes 41a and 41b connected to a power source 31 are arranged side by side in parallel to each other. At least one electrode of the paired electrodes 41a and 41b is covered with a dielectric substance 42, and a high frequency voltage is applied to a discharge space 43 formed between these electrodes by the power source 31.

The inside of each of the electrodes 41a and 41b is made into a hollow structure 44 so that during discharging, heat generated by the discharging is taken away by water or oil, whereby heat exchange can be made so as to maintain a stable temperature.

Moreover, gas 22 containing a discharge gas necessary for discharging is supplied to the discharge space 43 through a flow passage 24 by a gas supply means not mentioned here, and a high frequency voltage is applied to this discharge space 43 to generate plasma discharging so that the gas 22 containing the discharge gas is made into a plasma state. The gas 22 in the plasma state is made to blow off into the mixed space 45.

On the other hand, a mixed gas 23 containing gas necessary for the forming a transparent conductive layer is supplied by a gas supply means (un-illustrated), guided along a flow passage 25, and conveyed to the mixed space 45. Then, the mixed gas 23 is associated and mixed with the gas 22 in the plasma state. Subsequently, the resultant mixed gas is sprayed onto a transparent base board material mounted on a shifting stage 47 or a liquid crystal optical element unit 46 (hereafter, collectively called a base board material) including a transparent base board material on its uppermost surface.

The transparent conductive layer forming gas coming in contact with the mixed gas made in the plasma state is activated by the energy of plasma and causes a chemical reaction so that a transparent conductive layer is formed on a base board material 46.

This plasma jet type atmospheric pressure plasma discharge processing apparatus has a structure which is sandwiched or surrounded by a discharge gas in which a mixed gas containing gas necessary for forming a transparent conductive layer is activated.

The shifting stage 47 on which a base board material is mounted has a structure which can scan outward and home ward or continuously, and is structured, if needed, to be able to perform heat exchange so as to maintain a proper temperature of a base board material as same as the above mentioned electrode.

Moreover, a waste exhaust gas flow passage 48 to exhaust gas sprayed on a base board material 46 can also be attached, if needed. With this passage, unnecessary by-product generated in a space can be promptly removed from a discharge space 45 or a base board material 46.

This plasma jet type atmospheric pressure plasma discharge processing apparatus has a structure that a discharge gas is activated by being made in a plasma state, and then is associated with a mixed gas containing gas necessary for forming a transparent conductive layer. With this structure, it is possible to prevent a film-like product from depositing on the surface of an electrode. However, as disclosed in Japan Patent Application No. 2003-095367, by pasting a fouling prevention film on the surface of an electrode, it is possible to make a structure to mix a discharge gas and a gas necessary for forming a transparent conductive layer before discharging.

Further, in the apparatus shown in FIG. 4, there is provided a high frequency power source with a single frequency band. However, as disclosed in the official gazette of Japanese Patent Unexamined Publication No. 2003-96569, it is also possible to provide each of electrodes with respective power sources different in frequency.

Moreover, if a plurality of the above plasma jet type atmospheric pressure plasma discharge processing apparatuses is arranged in the scanning direction of a stage, it is possible to increase a film forming capacity.

Further, if a structure is made to enclose electrodes and the entire body of stage to prevent the outside air from entering, though such a structure is not shown in the plasma jet type atmospheric pressure plasma discharge processing apparatus, it is possible to make the inside of the apparatus into a predetermined gas atmosphere so that a desired high quality transparent antistatic film can be formed.

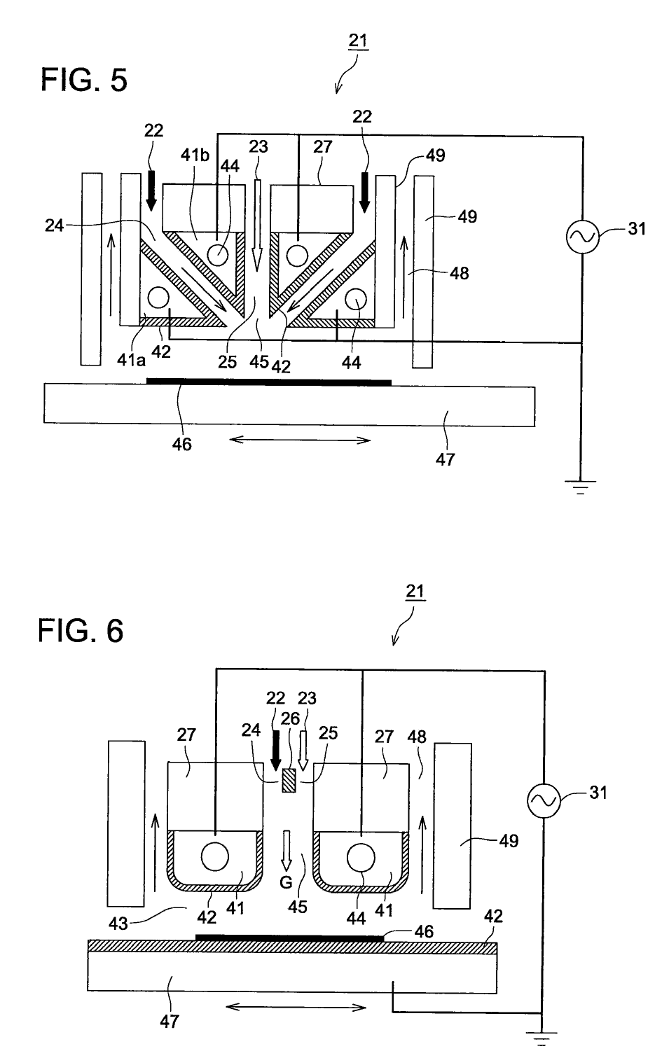

FIG. 5 is a schematic diagram showing another example of the plasma jet type atmospheric pressure plasma discharge processing apparatus according to the present invention.

In the above-mentioned FIG. 4, the flow passage 24 to supply gas 22 containing a discharge gas and the flow passage 25 to supply a mixed gas 23 containing gas necessary for forming a transparent conductive layer parallel are provided in parallel to each other. However, as shown in FIG. 5, these passage may be structured such that the flow passage 24 to supply gas 22 containing a discharge gas is formed obliquely so as to increase a mixing efficiency to mix the gas 22 with the gas 23 supplied from the passage 25.

FIG. 6 is a schematic diagram showing an example of a direct type atmospheric pressure plasma discharge processing apparatus according to the present invention.

In the direct type atmospheric pressure plasma discharge processing apparatus shown in FIG. 6, two electrodes 41 connected to a power source 31 are arranged side by side so as to become respectively in parallel to a shifting stage electrode 47. At least one of the electrodes 41 and the electrode 47 is covered with a dielectric substance 42, and a high frequency voltage is applied to a space 43 formed between the electrodes 41 and the electrode 47 by a power source 31.

Here, the inside of each of the electrodes 41 and the electrode 47 is made into a hollow structure 44 so that during discharging, heat generated by the discharging is taken away by water or oil, whereby heat exchange can be made so as to maintain a stable temperature.

Further, by respective gas supply means (un-illustrating), a gas 22 containing a discharge gas necessary for discharging passes along a flow passage 24 and enters into a mixing space 45, also a mixed gas 23 contains a gas necessary for forming a transparent conductive layer passes along a flow passage 25 and enters into the mixing space 45, and then the gas 22 and the gas 23 are associated and mixed in the mixing space 45. The resultant mixed gas G passes along between the electrodes 41, and is supplied into a space 43 between the electrodes 41 and the electrode 47. Subsequently, when a high frequency voltage is applied to the space 43, plasma discharge is generated in the space 43, whereby the gas G is made into a plasma state. By the gas G made in the plasma state, the gas for forming a transparent conductive layer is activated and causes a chemical reaction, whereby a transparent conductive layer is formed on a base board material 46 (a transparent base board material or a liquid crystal optical element unit including a transparent base material on its uppermost surface).

The shifting stage 47 on which a base board material is mounted has a structure capable of scanning outward and home ward or continuously, and is structured, if needed, to be able to perform heat exchange so as to maintain a proper temperature of a base board material as same as the above mentioned electrode.

Moreover, a waste exhaust gas flow passage 48 to exhaust gas sprayed on a base board material 46 can also be attached, if needed. With this passage, unnecessary by-product generated in a space can be promptly removed from a discharge space 45 or a base board material 46.

Further, as disclosed in Japan Patent Application No. 2003-095367, by pasting a fouling prevention film on the surface of an electrode, it is possible to make a structure to mix a discharge gas and a gas necessary for forming a transparent conductive layer before discharging.

Further, in the apparatus shown in FIG. 6, there is provided a high frequency power source with a single frequency band. However, as disclosed in the official gazette of Japanese Patent Unexamined Publication No. 2003-96569, it is also possible to provide each of electrodes with respective power sources different in frequency.

Moreover, if a plurality of the above direct type atmospheric pressure plasma discharge processing apparatuses is arranged in the scanning direction of a stage, it is possible to increase a film forming capacity.

Further, if a structure is made to enclose electrodes and the entire body of stage to prevent the outside air from entering, though such a structure is not shown in the direct type atmospheric pressure plasma discharge processing apparatus, it is possible to make the inside of the apparatus into a predetermined gas atmosphere so that a desired high quality transparent antistatic film can be formed.

### EXAMPLE

Hereafter, the present invention will be explained concretely with reference to examples. However, the present invention is not limited to these examples. Here, the indications “set” and “%” are used in the examples, as long as there is no specific notice, the above indications represent “parts by weight” and “% by weight”.

### Example 1

### Production of a Liquid Crystal Display Element

### [Production of Liquid Crystal Display Element 1]

### (Production of a Liquid-Crystal-Display Element Unit)

A full color liquid crystal display element unit composes of a structure described in FIG. 2 was produced in accordance with a method described in the official gazette of Japanese Patent Unexamined Publication No. 2002-258262. However, the unit was made in the situation that a liquid crystal 13 is not poured into a liquid crystal layer 3.

### (Formation of a Transparent Conductive Layer)

By the below-mentioned atmospheric pressure plasma process (the direct type atmospheric pressure plasma discharge processing apparatus), a transparent conductive layer was formed on a transparent base board material 5b (glass base board material) shown in FIG. 2. Here, this process is also referred to a plasma CVD method DP.

### <Atmospheric Pressure Plasma Discharge Processing Apparatus>

By the use of the direct type atmospheric pressure plasma discharge processing apparatus shown in FIG. 6, a transparent conductive layer was formed on the following film forming conditions.

### <Power Source Condition>

Power source: A high frequency power source manufactured by Pearl Kogyou Co., Ltd. high frequency side: 27 MHz 10 W/cm2

### <Electrode Condition>

A rectangular electrode of the second electrode (41 in FIG. 6) was produced such that a 30 mm size rectangular hollow titanium pipe was subjected to a ceramic spraying process to cover with a dielectric substance.

Thickness of the dielectric substance: 1 mm

Width of electrode: 300 mm

Temperature of applying electrode: 90° C.

Slit gap between the second electrodes: 1.0 mm

Gap between electrodes: 1.5 mm

### <Gas Condition>

Ar gas (tetramethyltin was evaporated by bubbling): 1 slm, 20° C.

Discharge gas: Ar, 50 slm

Auxiliary gas: H₂, 0.3 slm

### <Shifting Trestle Electrode (47 in FIG. 6)>

Material: SUS316L

Temperature of the shifting trestle electrode: 100° C.

The liquid crystal display element unit produced in the above was arranged on the shifting trestle electrode so as to make the transparent base board material 5b to become the uppermost plane, and a scanning processing was continuously performed under the condition of 20 mm/sec, whereby a 10 nm thick transparent conductive layer was formed.

### [Production of a Liquid Crystal Display Element 2]

By the use of the liquid crystal display element unit produced in the above liquid crystal display element 1 and by the below-mentioned atmospheric pressure plasma process (the plasma jet type atmospheric pressure plasma discharge processing apparatus), a transparent conductive layer was formed on a transparent base board material 5b shown in FIG. 2. Here, this process is also referred to a plasma CVD method PJ.

### <Atmospheric Pressure Plasma Discharge Processing Apparatus>

By the use of the plasma jet type atmospheric pressure plasma discharge processing apparatus shown in FIG. 4, a transparent conductive layer was formed on the following film forming conditions.

### <Power Source Condition>

Power source: A high frequency power source manufactured by Haiden Laboratory Inc.

high frequency side: 100 KHz 8 kV

### <Electrode Condition>

[Electrode 1 (41a Shown in FIG. 4)]

A rectangular electrode 41a was produced such that a 30 mm size rectangular hollow titanium pipe was subjected to a ceramic spraying process to cover with a dielectric substance.

Thickness of the dielectric substance: 1 mm

Width of electrode: 300 mm

Temperature of applying electrode: 90° C.

[Electrode 2 (41b shown in FIG. 4)]

A rectangular electrode 41b was produced such that a 4 mm thick titanium plate was subjected to a ceramic spraying process to cover with a dielectric substance. Further, as shown in FIG. 4, a 20 mm size rectangular hollow titanium pipe was attached to the electrode 41b as an cooling member.

Gap between the electrodes (discharging): 0.5 mm

Gap between shifting trestle and electrode: 1.0 mm

### <Gas Condition>

Ar gas (tetramethyltin was evaporated by bubbling): 1 slm, 20° C.
Discharge gas: Ar, 100 slm
Auxiliary gas: O₂, 0.3 slm

The liquid crystal display element unit produced in the above was arranged on the shifting trestle so as to make the transparent base board material 5b to become the uppermost plane, and a scanning processing was continuously performed under the condition of 10 mm/sec, whereby a 10 nm thick transparent conductive layer was formed.

### [Production of a Liquid Crystal Display Element 3]

By the use of the liquid crystal display element unit produced in the above liquid crystal display element 1 and by the below-mentioned sputtering process, a transparent conductive layer was formed on a transparent base board material 5b shown in FIG. 2.

### (Formation of a Transparent Conductive Layer by a Sputtering Process)

In₂O₃ powder (purity of 99.99%) and SnO₂ powder (purity of 99.99%) were mixed with a mixing ratio of 92:8, and the mixed powder was shaped in a predetermined form and calcined, whereby an In₂O₃—SnO₂ based high density sintered body with a diameter of 20 cm was produced. The thus obtained In₂O₃—SnO₂ based high density sintered body was mounted on a batch type DC magnetron sputtering apparatus and a transparent conductive layer was formed. The magnetic flux density on a target was set to 1000 Gauss. As a sputtering gas, argon gas and a mixed gas of argon and oxygen were used, the argon gas and the mixed gas were introduced into a chamber through respective passages. The ultimate vacuum in the chamber was 5×10⁻⁴ Pa or less, and the gas pressure at the time of sputtering was made to 0.5 Pa. It was taken 10 minutes to form an In₂O₃—SnO₂ based transparent conductive layer with a thickness of 10 nm on a transparent base board material 5b of a liquid crystal display unit heated to 100° C.

### [Production of a Liquid Crystal Display Element 4]

By the use of the liquid crystal display element unit produced in the above liquid crystal display element 1 and by the below-mentioned coating process, a transparent conductive layer was formed on a transparent base board material 5b shown in FIG. 2.

### (Preparation of a Dispersion Liquid of Sn Doped Indium Oxide (ITO) Fine Particles A)

A solution obtained by dissolving 80 g of indium nitrate in 700 g of water and a solution obtained by dissolving 12 g of potassium stannate in a potassium hydroxide solution with a concentration of 10% by weight were prepared, and these solutions were added into 1000 g of pure water kept at 50° C. over 1 hour while pH in a system was held at 11. From the obtained Sn doped indium oxide hydrate dispersion liquid, Sn doped indium oxide hydrate was filtered, washed with water, and thereafter dispersed again in water, whereby a metal oxide precursor hydroxide dispersion liquid with a solids concentration of 10% by weight was prepared. Then, this metal oxide precursor hydroxide dispersion liquid was sprayed at a temperature of 100° C. and dried, whereby metal oxide precursor hydroxide fine particles were prepared. These metal oxide precursor hydroxide fine particles were heat-treated at 550° C. under a nitrogen gas atmosphere for 2 hours.

Subsequently, these fine particles were dispersed into ethanol to become a concentration of 30% by weight, and then the PH of the resultant dispersion liquid was adjusted to become 3.5 with a nitric acid solution. Thereafter, the dispersion liquid was pulverized by a sand mill for 0.5 hour while being kept at 30° C., whereby sol was prepared. Next, ethanol was added in the sol so as to prepare a Sn doped indium oxide fine particle dispersion liquid A with a concentration of 20% by weight. The average particle size was measured by SEM and the resultant measurement was 25 nm.

### (Preparation of a Color Particle B Dispersion)

Thirty two g of carbon black fine particles (produced by Mitsubishi Chemical Co., Ltd.: MA230), 268 g of ethyl alcohol, 40 g of tetra-butoxyzirconium (produced by Nippon Soda Co., Ltd.: ZR-181 and a ZrO₂ concentration of 15% by weight), and 3 g of 6% by weight nitric acid were mixed, the resultant mixed liquid was processed by a sand mill for 1.5 hours, whereby a color particle dispersion liquid B with a solid concentration of 9.7% by weight was prepared. The average particle size of the carbon black fine particles in the color fine particle dispersion liquid B was 40 nm.

### (Preparation of a Coating Liquid for Forming a Transparent Conductive Layer)

The above-prepared Sn doped indium oxide (ITO) fine particle A dispersion liquid and the color particle B dispersion liquid were mixed with a mixing ratio of 86:14. Further, the resultant mixed liquid was diluted with a polar solvent (ethanol/isopropylglycol/diacetone alcohol=80/15/5 in weight ratio) so that the solid concentration became 1.0%, whereby a coating liquid for forming a transparent conductive layer was prepared.

(Formation of a Transparent Conductive Layer)

While holding a liquid crystal display element unit at 35° C., the above coating liquid for forming a transparent conductive layer was coated on a transparent base board material 5b by a spinner process under the conditions of 200 rpm and 90 seconds, and dried. At this time, the thickness was 80 nm. Subsequently, a baking treatment was performed at 180° C. for 30 minutes, whereby a transparent conductive layer was formed.

### <<Evaluation of a Liquid Crystal Display Element>>

### [Evaluation of the Degree of Influence to a Liquid Crystal Display Element]

### (Evaluation of the Working Characteristics of Display Elements)

After liquid crystal was injected into a liquid crystal layer of each of the produced liquid crystal display elements, the produced liquid crystal display elements were made to work and the existence of poor working due to short circuits and the like was checked. As a result of the check, the case where the elements worked normally was evaluated as the rank “A”, and the case where the elements caused working failure due to short circuits and the like was evaluated as the rank “C”.

### (Evaluation of the Suitability as a Transparent Base Board Material)

Visual observation to check the occurrence of breakage was conducted for the transparent base board material 5b of each of the produced liquid crystal display elements on which the transparent conductive layer was formed. As a result of the check, the case where breakage did not occur was evaluated as the rank “A”, and the case where breakage occurred even on a part was evaluated as the rank “C”.

### (Evaluation of the Productivity of a Transparent Conductive Layer: Measurement of Film Forming Time)

The time taken to form a transparent conductive layer on a transparent base board material was measured, and the measured time was used for the evaluation of the productivity.

### [Evaluation of the Optical Transparency of a Transparent Conductive Layer]

After the above-mentioned liquid crystal display elements were produced, the liquid crystal display elements were disassembled and the transparent base board material 5b on which the transparent conductive layer was formed was taken out from the elements. Then, the surface of the transparent base board material opposite to the surface on which the transparent conductive layer was formed, was subjected to mechanical polishing so as to reduce the thickness of the transparent base board material to 0.3 mm, and the transmittance A of the transparent base board material was measured. Similarly, the transparent base board material on which the transparent conductive layer was not provided was subjected to mechanical polishing so as to reduce the thickness of the transparent base board material to 0.3 mm, and the transmittance B of the transparent base board material was measured. Then, the transmittance C of the transparent conductive layer was obtained by the following formula. Here, the transmittance was measured by the use of a measuring device of V-530 manufactured by JASCO Corporation with a wavelength of 550 nm.

Transmittance C of a transparent conductive layer=(Transmittance A/Transmittance B)×100

The case where the transmittance C of a transparent conductive layer obtained in accordance with the above measurement was 99% or more was evaluated as the rank “A”, the case where the transmittance C was in the range of 96% to 98% was evaluated as the rank “B”, and the case where the transmittance C was 95% or less was evaluated as the rank “C”.

### [Measurement of the Surface Specific Resistance of a Transparent Conductive Layer]

The surface resistivity (Ω/□) of each transparent conductive layer was measured by the use of Highrester IP (MCP-HT450) and probe MCP-HTP12 produced by Mitsubishi Chemical holding company with an applied voltage of 10 V and a measurement time of 10 seconds under the condition of normal temperature and normal humidity (26° C., Relative humidity of 50%).

In the result, the case where the surface specific resistance value obtained by the above measurement was less than 1×10⁵ (Ω/□) was evaluated as the rank “A”, the case where the surface specific resistance value was 1×10⁵ (Ω/□) or more and less than 1×10⁸ (Ω/□) was evaluated as the rank “B”, and the case where the surface specific resistance value was 1×10⁸ (Ω/□) or more was evaluated as the rank “C”.

### [Evaluation of the Adhesive Ability of a Transparent Conductive Layer]

By the use of an adhesive cellophane tape (industrial-use 24 mm width cellophane tape produced by the Nichiban Co., Ltd.), attaching the tape and peeling the tape were repeated 10 times on the same position of the surface of each transparent conductive layer, the number of tape peeling operations until the transparent conductive layer was peeled off was counted, and the adhesive ability was evaluated in accordance with the following criterion.

A: Even after the peeling operation was conducted 10 times, a transparent conductive layer was not peeled off.

B: When the peeling operation was conducted 4 to 9 times, a transparent conductive layer was peeled off.

C: When the first time of the peeling operation was conducted, a transparent conductive layer was peeled off.

The results obtained by the above are indicate in Table 1.

TABLE 1

| | | Degree of influence | | | | | | |
|---|---|---|---|---|---|---|---|---|
| | | for display elements | | | | | | |
| Liquid | Transparent | | Suitability | | Characteristics of the formed | | | |
| crystal | conductive | | as | | transparent conductive layer | | | |
| display | layer | Working | transparent | | | Surface | | |
| element | forming | character- | base board | | Optical | specific | Adhesive | |
| No. | method | istics | material | Productivity | transparency | resistance | ability | Remarks |
| 1 | Plasma CVD | A | A | A | A | A | A | Inventive |
| | method DP | | | | | | | |
| 2 | Plasma CVD | A | A | A | A | A | A | Inventive |
| | method PJ | | | | | | | |
| 3 | Sputtering | C | B | B | B | A | B | Comparative |
| | method | | | | | | | |
| 4 | Coating | A | A | C | C | C | C | Comparative |
| | method | | | | | | | |

As it is clear from the result indicated in Table 1, as compared with Comparative example, in the samples of the present invention in which a transparent conductive layer was formed by an atmospheric pressure plasma process employing rare gas (argon gas) as a thin layer forming gas specified in the present invention, it turns out that the samples have no influence for structural components of a liquid crystal display element, are excellent in the productivity and are excellent in optical transparency of the formed transparent conductive layer, conductivity (the surface specific resistance) and adhesive ability with a transparent base board material.

### Example 2

### Production of a Liquid Crystal Display Element

The liquid crystal display elements 5 to 8 were produced in the same way as that in the production of the liquid crystal display elements 1 to 4 in Example 1, except that sealing members are provided onto peripheral regions surrounding a display region on the lower transparent base board before the upper transparent base board is stacked onto the lower transparent base board, and liquid crystal was dropped there by ODF method, subsequently the upper transparent base board was stacked onto the lower transparent base board so as to form a liquid crystal layer. Then, a transparent conductive layer was formed by each of the methods described in Example 1 on the condition that liquid crystal existed in the liquid crystal layer. The transparent conductive layer forming methods used in the production of the liquid crystal display elements 5 to 8 correspond to the transparent conductive layer forming methods used in the production of the liquid crystal display elements 1 to 4.

### [Evaluation of Liquid Crystal Display Elements]

With the same way as that in Example 1, each of the above-produced liquid crystal display elements were evaluated in terms of productivity, optical transparency (transmittance state) of a transparent conductive layer, surface specific resistance (conductivity) and adhesive ability. In addition, liquid crystal resistance was evaluated in accordance with the following method.

### (Evaluation of Liquid Crystal Resistance)

The existence of bubble generation and the existence of coloring in a liquid crystal layer of the produced liquid crystal display elements were checked and the liquid crystal resistance was evaluated in accordance with the following criterion.

A: Bubble generation in a liquid crystal layer was not observed and the quality of the liquid crystal was not changed.

B: Submicroscopic bubble generation in a liquid crystal layer was slightly observed, but the quality of the liquid crystal was not changed and is allowed for practical use.

C: Bubble generation in a liquid crystal layer was observed clearly.

D: Bubble generation in a liquid crystal layer was observed clearly and the changed quality of the liquid crystal was observed.

The results obtained by the above are indicate in Table 2.

TABLE 2

| Liquid | Transparent | | | Characteristics of the formed | | | |
|---|---|---|---|---|---|---|---|
| crystal | conductive | | | transparent conductive layer | | | |
| display | layer | Liquid | | | Surface | | |
| element | forming | crystal | | Optical | specific | Adhesive | |
| No. | method | resistance | Productivity | transparency | resistance | ability | Remarks |
| 5 | Plasma CVD | A | A | A | A | A | Inventive |
| | method DP | | | | | | |
| 6 | Plasma CVD | A | A | A | A | A | Inventive |
| | method PJ | | | | | | |
| 7 | Sputtering | C | B | B | A | B | Comparative |
| | method | | | | | | |
| 8 | Coating | D | C | C | C | C | Comparative |
| | method | | | | | | |

As it is clear from the result indicated in Table 2, in the samples of the present invention in which a transparent conductive layer was formed by an atmospheric pressure plasma process employing rare gas (argon gas) as a thin layer forming gas specified in the present invention after liquid crystal was filled by the ODF method, it turns out that the samples have no influence for a liquid crystal layer, are excellent in the productivity and are excellent in optical transparency of the formed transparent conductive layer, conductivity (the surface specific resistance) and adhesive ability with a transparent base board material.

1-8. (canceled)

9. A method of manufacturing a liquid crystal display device which is provided with a liquid crystal display panel including a liquid crystal layer, a first transparent base board pasted on an display surface side of the liquid crystal layer and a second transparent base board pasted on a back side of the liquid crystal layer, and a backlight unit to make light to transmit toward the display surface side of the liquid crystal display panel, comprising:
a step of making a mixed gas including a transparent conductive layer forming gas and at least a rare gas as a discharging gas into an excited state by an atmospheric pressure plasma process such that a transparent conductive layer is formed on the display side surface of the first transparent base board.

10. The method described in claim 9, wherein the liquid crystal display panel further includes a display electrode and a reference electrode on the surface of an image forming region of at least one of the first transparent base board and the second transparent base board and the liquid crystal display panel employs a transverse electric field technique to modulate light passing the liquid crystal layer by an electric field generated in parallel to the transparent base board between the reference electrode and at least the display electrode to which picture signals are supplied from picture signal lines through switching elements.

11. The method described in claim 9, wherein the rare gas is argon gas.

12. The method described in claim 9, wherein after liquid crystal was filled in a space between the first transparent base board and the second transparent base board so that the liquid crystal layer was formed, the transparent conductive layer is formed on the display side surface of the first transparent base board.

13. The method described in claim 9, wherein the transparent conductive layer forming gas includes at least one of dibutyltin diacetate, tetrabutyltin, and tetra-methyl tin and forms a tin oxide layer as the transparent conductive layer.

14. The method described in claim 9, wherein the transparent conductive layer has a specific surface resistance value less than 1×10⁵ (Ω/□).

15. The method described in claim 9, wherein the transparent conductive layer is a transparent antistatic film.

16. A liquid crystal display device, comprising:
a liquid crystal display panel including a liquid crystal layer, a first transparent base board pasted on an display surface side of the liquid crystal layer and a second transparent base board pasted on a back side of the liquid crystal layer, and
a backlight unit to make light to transmit toward the display surface side of the liquid crystal display panel,
wherein the first transparent base board includes a transparent conductive layer on the display side surface thereof and the transparent conductive layer is formed on the first transparent base board in such as way that a mixed gas including a transparent conductive layer forming gas and at least a rare gas as a discharging gas is made into an excited state by an atmospheric pressure plasma process.

17. The liquid crystal display device described in claim 16, wherein the liquid crystal display panel further includes a display electrode and a reference electrode on the surface of an image forming region of at least one of the first transparent base board and the second transparent base board and the liquid crystal display panel employs a transverse electric field technique to modulate light passing the liquid crystal layer by an electric field generated in parallel to the transparent base board between the reference electrode and at least the display electrode to which picture signals are supplied from picture signal lines through switching elements.

18. The liquid crystal display device described in claim 16, wherein the rare gas is argon gas.

19. The liquid crystal display device described in claim 16, wherein after liquid crystal was filled in a space between the first transparent base board and the second transparent base board so that the liquid crystal layer was formed, the transparent conductive layer is formed on the display side surface of the first transparent base board.
